(19) United States
(12) Patent Application Publication
(10) Pub. No.: US 2024/0072593 A1
(43) Pub. Date: Feb. 29, 2024

(54) STATOR

(71) Applicant: Schaeffler Technologies AG & Co. KG, Herzogenaurach (DE)

(72) Inventors: Oliver ERNST, Bühl (DE); Fabian OEHLER, Wachenheim (DE)

(73) Assignee: Schaeffler Technologies AG & Co. KG, Herzogenaurach (DE)

(21) Appl. No.: 18/280,307

(22) PCT Filed: Feb. 8, 2022
(86) PCT No.: PCT/DE2022/100107

§ 371 Date: Sep. 5, 2023

(30) Foreign Application Priority Data
Mar. 5, 2021 (DE) 10 2021 105 323.4

(51) Int. Cl. H02K 3/28

(52) U.S. Cl. CPC H02K 3/28

(57) ABSTRACT

A stator for an electric machine, in particular for use in a hybrid or fully electric drive train of a motor vehicle. The stator has a cylindrical opening which extends axially through the stator and on which a plurality of stator slots are present, the stator slots being arranged in a peripherally distributed manner and extending radially outward from an inner cylinder jacket surface of the cylindrical opening and being formed over the entire axial length of the stator. The, stator slots each have a slot base on the radially outer end thereof and an air gap to a rotor, which can be received in the cylindrical opening, on the radially inner end thereof. The stator windings have winding wires arranged in the stator slots and the stator windings are designed as a wave winding having a first winding mat and a second winding mat.

### CROSS-REFERENCE TO RELATED APPLICATION

This application is the U.S. National Phase of PCT Appln. No. PCT/DE2022/100107, filed Feb. 8, 2022, which claims priority from German Patent Application No. 10 2021 105 323.4, filed Mar. 5, 2021, the entire disclosures of which are incorporated by reference herein.

### TECHNICAL FIELD

The present disclosure relates to a stator for an electric machine, in particular for use in a hybrid or fully electric drive train of a motor vehicle, wherein the stator has a cylindrical opening which extends axially through the stator and on which a plurality of stator slots are present, said stator slots being arranged in a peripherally distributed manner and extending radially outward from an inner cylinder jacket surface of the cylindrical opening and being formed over the entire axial length of the stator, wherein the stator slots each have a slot base on the radially outer end thereof and an air gap to a rotor, which can be received in the cylindrical opening, on the radially inner end thereof, wherein stator windings having winding wires are arranged in the stator slots and the stator windings are designed as a wave winding having a first winding mat and a second winding mat.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

However, there is still an ongoing need to further optimize such electric motors for the mass market, in particular in terms of production costs. A major cost factor in the production of these electric motors is the winding and interconnection of the stator windings.

Stators for electric machines with a wave winding are also known from the prior art for use in drive trains of motor vehicles. In such a wave winding, the individual winding wires are not routed in a circular manner between two stator slots, but loop successively through all the stator slots of a stator according to a wave form. This allows automated production equipment to be used, enabling suitably wound stators to be produced more efficiently and economically.

If a winding configuration with two or more winding mats is required for these generic stators, the respective winding ends of the winding mats usually abut the stator circumferentially offset by 180°. This large circumferential distance of the winding ends leads to an increased interconnection effort as well as a more complex and expensive production, since the interconnection usually has to be realized by means of one or more additional interconnection rings. Although this reduces the complexity of the production process by means of a predefined positioning in it for each winding end, the additional production effort and the associated costs for this additive component are disadvantageous. As an alternative to the use of an interconnection ring, the winding ends can also be interconnected directly, but this involves a significant increase in complexity and cost in the production of such stators.

DE102008007409A1 describes, for example, a three-part switching ring for a stator, wherein three busbars and a star point ring are arranged in one plane, lying flat next to one another in a carrier ring made of a temperature-resistant plastic. The contact points of the busbars and the star point ring project from the carrier ring and are connected to the wire ends of the partial windings of the stator.

### SUMMARY

The object of the present i disclosure is now to provide a stator which at least mitigates or completely eliminates the described disadvantages of the prior art and in which an interconnection of a stator winding with at least two winding mats can be realized in a simple and cost-optimized manner without the use of interconnection rings.

This object is achieved by a stator for an electric machine, in particular for use in a hybrid or fully electric drive train of a motor vehicle, wherein the stator has a cylindrical opening which extends axially through the stator and on which a plurality of stator slots are present, said stator slots being arranged in a peripherally distributed manner and extending radially outward from an inner cylinder jacket surface of the cylindrical opening and being formed over the entire axial length of the stator, wherein the stator slots each have a slot base on the radially outer end thereof and an air gap to a rotor, which can be received in the cylindrical opening, on the radially inner end thereof, wherein stator windings having winding wires are arranged in the stator slots and the stator windings are designed as a wave winding having a first winding mat and a second winding mat, wherein the first winding mat has a group of first winding wires, the winding ends of which are each arranged above the same stator slot in each case, and the winding ends of the first group of winding wires each have a first winding end and a second winding end, wherein the first winding end of the first group of winding wires abuts facing the slot base and the second winding end of the first group of winding wires abuts facing the air gap of this stator slot and the second winding mat has a group of second winding wires, the winding ends of which are each arranged above the same stator slot in each case, and the winding ends of the second group of winding wires each have a first winding end and a second winding end, wherein the first winding end of the second group of winding wires abuts facing the slot base and the second winding end of the second group of winding wires abuts facing the air gap of this stator slot.

The advantage of the stator according to the disclosure is thus that an additional interconnection ring can be dispensed with, since no interconnection of winding wire ends in the circumferential direction from one side of the stator to the opposite side is required in order to interconnect the winding wire ends. The stator according to the disclosure allows interconnections only within two poles, which reduces the production effort and cost of the stator winding interconnection.

First, the individual elements of the claimed subject matter of the disclosure are explained in the order in which they are named in the claims and particularly preferred embodiments of the subject matter according to the disclosure are described below.

The stator according to the disclosure is configured in particular for use within an electric machine designed as a radial flux machine.

Electric machines are used to convert electrical energy into mechanical energy and/or vice versa, and generally comprise a stationary part referred to as a stator, stand or armature, and a part referred to as a rotor or runner and arranged movably relative to the stationary part.

The electric machine is intended in particular for use within a drive train of a hybrid or fully electric motor vehicle. In particular, the electric machine is dimensioned such that vehicle speeds of more than 50 km/h, preferably more than 80 km/h and in particular more than 100 km/h can be achieved. The electric motor particularly preferably has an output of more than 30 kW, preferably more than 50 kW and in particular more than 70 kW. Furthermore, it is preferred that the electric machine provides speeds greater than 5,000 rpm, particularly preferably greater than 10,000 rpm, very particularly preferably greater than 12,500 rpm.

The stator has a cylindrical structure and preferably consists of electrical laminations that are electrically insulated from one another, constructed in layers and packaged to form laminated cores. With this structure, the eddy currents in the stator caused by the stator field are kept low. Distributed around the circumference, stator slots are embedded into the electrical lamination running parallel to the rotor shaft, which receive the stator winding or parts of the stator winding. Depending on the construction towards the surface, the stator slots can be closed with closing elements, such as closing wedges or covers or the like, to prevent the stator winding from detaching.

Stator teeth are components of the stator which are designed as circumferentially spaced, tooth-like parts of the stator directed radially inward or radially outward and between whose free ends and a rotor body an air gap for the magnetic field is formed.

A stator winding is an electrically conductive conductor whose length extension is much greater than its diameter. The stator winding can generally have any cross-sectional shape. Rectangular cross-sectional shapes are preferred, as these allow for high packing densities and consequently high power densities to be achieved. Particularly preferably, a stator winding is formed of copper. Preferably, a stator winding has an insulation.

In particular, the stator can be provided for use in an electric machine within a drive train of a motor vehicle. In the context of this application, the drive train of a motor vehicle is understood to mean all components that generate the power for driving the motor vehicle in the motor vehicle and transmit it to the road via the vehicle wheels.

The stator can also preferably be provided for use in an electric machine within a hybrid module for a motor vehicle. In a hybrid module, structural and functional elements of a hybridized drive train can be spatially and/or structurally combined and preconfigured so that a hybrid module can be integrated into a drive train of a motor vehicle in a particularly simple manner. In particular, an electric machine and a clutch system, in particular with a separating clutch for engaging the electric machine in and/or disengaging the electric machine from the drive train, can be present in a hybrid module.

In particular, the stator can also preferably be provided for use in an electric axle drive train within a drive train of a motor vehicle. An electric axle drive train of a motor vehicle comprises an electric machine and a transmission, wherein the electric machine and the transmission form a structural unit. This structural unit is sometimes also referred to as an E-axle.

According to an advantageous embodiment, the winding ends of the first group of winding wires and the winding ends of the second group of winding wires can be arranged opposite each other in the circumferential direction in the stator slots of the stator.

In accordance with a further preferred further development of the disclosure, the first winding mat and the second winding mat can be formed substantially identically, whereby the production costs of the stator can be further optimized by reducing the complexity of the components used.

Furthermore, according to a likewise advantageous embodiment, the winding ends of the first group of winding wires can be arranged in circumferentially adjacent stator slots and/or the winding ends of the second group of winding wires can be arranged in circumferentially adjacent stator slots, which further reduces the interconnection effort due to the corresponding spatial proximity of the winding ends to be interconnected.

According to a further particularly preferred embodiment, the stator windings can be designed for use, in particular, in a 3-phase rotating field machine.

Furthermore, the disclosure can also be further developed in that the interconnection of the first group of winding wires of the first winding mat and the second group of winding wires of the second winding mat is identical, thereby realizing a reduction in complexity and cost by using identical components. Furthermore, the use of identical winding mats allows for a simplified installation of the winding mats.

In a likewise preferred embodiment, the stator windings can have a number n of more than two winding mats, and the winding mats can be arranged circumferentially offset from one another by n/360° in the stator slots of the stator. This allows for a simple design adjustment of the electric machine, for example by adjusting the number of parallel branches and/or the number of winding mats. Furthermore, a reduction in complexity can be achieved by using the same interconnection for different designs in the production and assembly of an electric machine wound in this manner.

### BRIEF DESCRIPTION OF THE DRAWINGS

The disclosure will be explained in more detail below with reference to figures without limiting the general concept according to the disclosure.

In the figures:

FIG. 1 shows a cross-sectional view of an electric machine with a stator,

FIG. 2 shows a motor vehicle with a hybrid and fully electric drive train in a schematic block diagram view,

FIG. 3 shows a wound stator in a schematic view of a winding head end of the stator,

FIG. 3A shows a wound stator in a schematic cross-sectional view,

FIG. 4 shows an interconnection diagram of a stator with 36 stator slots and two winding mats.

### DETAILED DESCRIPTION

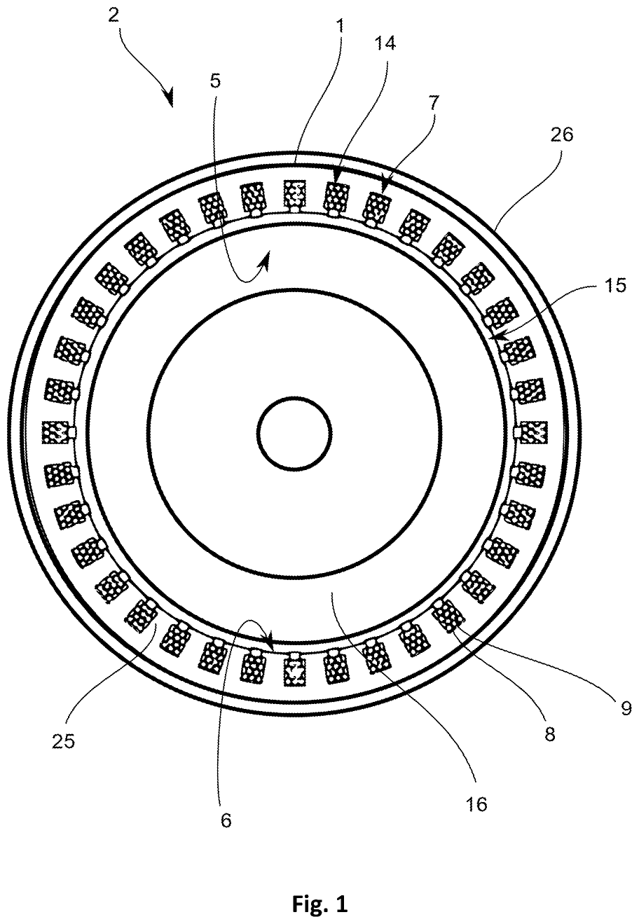

FIG. 1 shows a stator 1 for an electric machine 2. The electric machine 2 is configured as a radial flux machine in which a cylindrical rotor 24 rotates within the stator 1 of the electric machine 2. The stator 1 has a cylindrical opening 5 corresponding to the rotor 24 which extends axially through the stator 1 and on which a plurality of stator slots 7 are present, said stator slots being arranged in a peripherally distributed manner and extending radially outward from an inner cylinder jacket surface 6 of the cylindrical opening 5 and being formed over the entire axial length of the stator 1.

The stator slots 7 each have a slot base 14 on the radially outer end thereof and an air gap 15 to a rotor 16, which can be received in the cylindrical opening 5, on the radially inner end thereof. The stator windings 8 are arranged with winding wires 9 in the stator slots 7.

The stator windings 8 are formed as a wave winding with a first winding mat 10 and a second winding mat 11, wherein the first winding mat 10 and the second winding mat 19 are formed substantially identically.

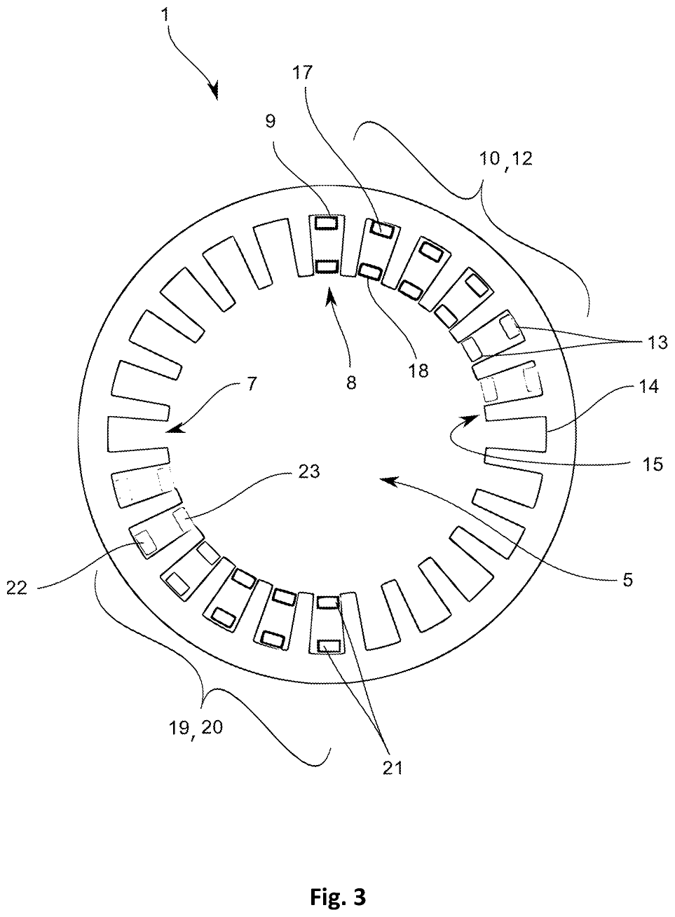

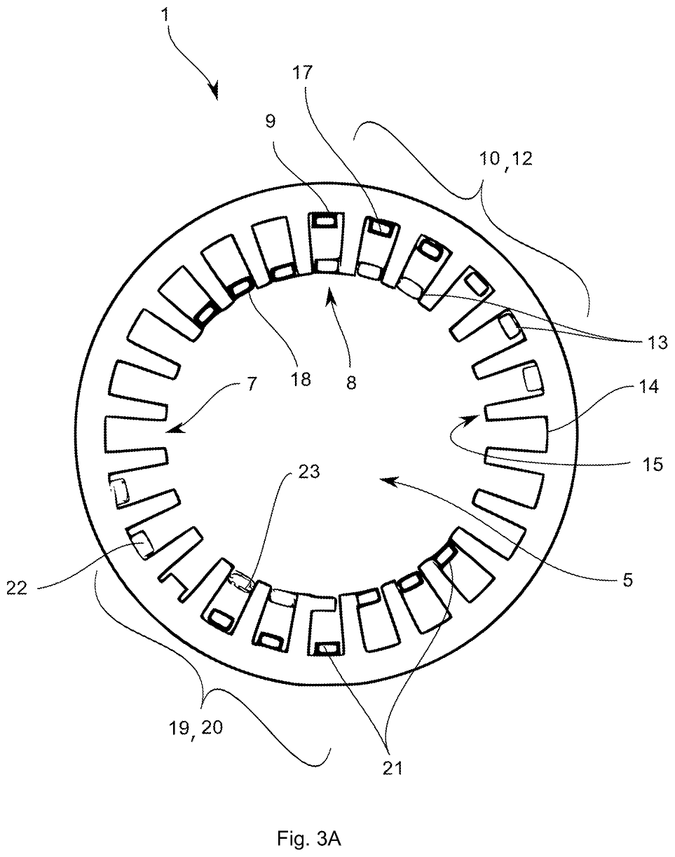

FIG. 3 shows an embodiment of the stator 1 with 24 stator slots 7 distributed equidistantly over the circumference of the cylindrical stator 1 and formed essentially identically. In this view of the winding head, the winding ends 13, 21 are positioned above the stator slots 7 in the axial direction. From the representation in FIG. 3A, which shows a cross-sectional view, it can be seen that the winding ends 13,21 extend through the stator slots 7 offset from one another in the circumferential direction. The winding ends 22,23, for example, do not end in the same stator slots 7, but extend through the stator 1 offset by one pole, which can be seen well in FIG. 3A. In the embodiments of FIGS. 3,3A, a pole is formed by the windings in three successive stator slots 7. Twisting the wave winding 8 moves the winding ends 22,23 towards one another so that the winding ends 22,23 end over the same stator slot 7 as shown in the top view of the winding head of FIG. 3.

Referring to FIG. 3, it can be seen that the first winding mat 10 has a group of first winding wires 12, the winding ends 13 of which are each arranged above the same stator slot 7 in each case, and the winding ends 13 of the first group of winding wires 12 each have a first winding end 17 and a second winding end 18. The first winding end 17 of the first group of winding wires 12 abuts facing the slot base 14 and the second winding end 18 of the first group of winding wires 12 abuts facing the air gap 15 of this stator slot 7.

Similarly, the second winding mat 19 has a group of second winding wires 20, the winding ends 21 of which are each arranged above the same stator slot 7 in each case, and the winding ends 21 of the second group of winding wires 20 each have a first winding end 22 and a second winding end 23. The first winding end 22 of the second group of winding wires 20 is positioned facing the slot base 14, and the second winding end 23 of the second group of winding wires 20 is positioned facing the air gap 15 of this stator slot 7.

FIG. 3 further shows that the winding ends 13 of the first group of winding wires 12 and the winding ends 21 of the second group of winding wires 20 are arranged opposite each other in the circumferential direction in the stator slots 7 of the stator 1. The winding ends 13 of the first group of winding wires 12 and the winding ends 21 of the second group of winding wires 20 are arranged in circumferentially adjacent stator slots 7.

In principle, it is possible for the winding ends 22,23 to exit the stator slots 7 of the stator 1 at a common winding head end or at different winding head ends.

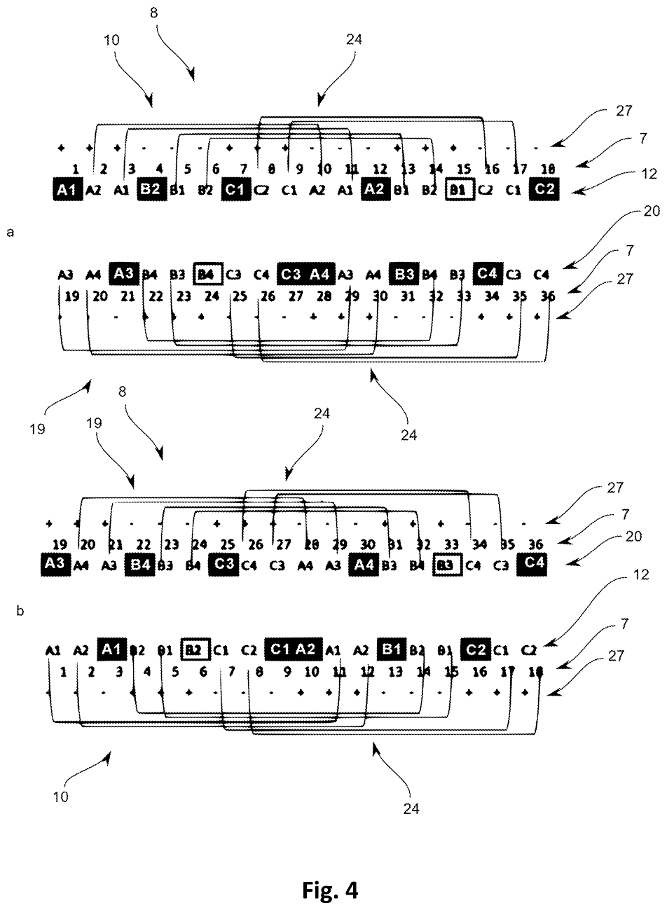

FIG. 4 shows a possible embodiment of an interconnection topology of the stator winding 8 with two winding mats 10,19. The stator windings 8 shown are designed for use in a 3-phase rotating field machine. In the embodiment shown in FIG. 4, the region of the interconnection of the stator 1 has a total of 36 slots 7. It should be noted at this point that FIG. 4 thus does not show an interconnection topology of the stator 1 with 24 slots known from FIGS. 3,3A. The magnetic polarity 27 generated in a slot 7 is indicated by a “+” or “−” above or below the digit designating the sequence of a slot 7. Furthermore, the individual winding wires 12,20 are alphanumerically designated, wherein the letter indicates the phase of a winding wire 12,20 and the following number indicates the group associated with a winding wire 12,20. The framed alphanumerically designated winding wires 12,20 identify their respective winding ends in each case.

In the exemplary embodiment shown in FIG. 4, there are thus four parallel branches (groups/1,2,3,4) and three phases (A,B,C).

The upper interconnection diagram, designated with “a”, shows the interconnection on the first end face of the stator 1, and the lower interconnection diagram, designated with “b”, shows the interconnection on the second end face of the stator 1.

In the exemplary embodiment shown in FIG. 4, two winding mats 10,19, each with 18 winding wires 12,20, are arranged offset from one another by 180° around the circumference of the stator. Consequently, the first winding mat 10 is inserted in the slots 1-18, while the second winding mat 19 is arranged in the slots 19-36.

The winding wires 12,20 of a winding mat 10,19 extend in the radial direction starting at one of the end faces of the stator 1 near the yoke of a slot 7 in order to extend through it in the axial direction and exit the corresponding slot 7 on the opposite end face of the stator.

Irrespective of the interconnection design, the number of windings depends, in this regard, on the number of slots 7 and the number of winding wires 12,20 per slot 7. This means that both a motor with 36, 54, 72 or 90 slots 7 and with 4, 6, 8, etc. conductors per slot can be interconnected in the same way.

This can also be seen well in the identical designations of the windings in the sequence A1,A2,A1,B2,B1,B2,C1,C2,C1,A2,A1,A2,B1,B2,B1,C2,C1,C2 in the stator slots 7 with the numbers 1-18 on the first end face “a” and the second end face “b” of the stator 1 for the first winding mat 10 and the identical designations of the windings in the sequence A3,A4,A3,B4,B3,B4,C3,C4,C3,A4,A3,A4,B3,B4,B3,C4,C3,C4 in the stator slots 7 with the numbers 19-36 on the first end face “a” and the second end face “b” of the stator 1 for the second winding mat 19.

The interconnection of the first winding mat 10 in the exemplary embodiment shown in FIG. 4 is made on the first end face “a” as follows:
The winding wire 12 in the slot 7 with the number 2 is electrically connected to the winding wire 12 in the slot 7 with the number 10.
The winding wire 12 in the slot 7 with the number 3 is electrically connected to the winding wire 12 in the slot 7 with the number 11.
The winding wire 12 in the slot 7 with the number 5 is electrically connected to the winding wire 12 in the slot 7 with the number 13.
The winding wire 12 in the slot 7 with the number 6 is electrically connected to the winding wire 12 in the slot 7 with the number 14.
The winding wire 12 in the slot 7 with the number 8 is electrically connected to the winding wire 12 in the slot 7 with the number 16.
The winding wire 12 in the slot 7 with the number 9 is electrically connected to the winding wire 12 in the slot 7 with the number 17.

The interconnection of the first winding mat 10 in the exemplary embodiment shown in FIG. 4 is made on the first end face “b” as follows:
The winding wire 12 in the slot 7 with the number 1 is electrically connected to the winding wire 12 in the slot 7 with the number 11.
The winding wire 12 in the slot 7 with the number 2 is electrically connected to the winding wire 12 in the slot 7 with the number 12.
The winding wire 12 in the slot 7 with the number 4 is electrically connected to the winding wire 12 in the slot 7 with the number 14.
The winding wire 12 in the slot 7 with the number 5 is electrically connected to the winding wire 12 in the slot 7 with the number 15.
The winding wire 12 in the slot 7 with the number 7 is electrically connected to the winding wire 12 in the slot 7 with the number 17.
The winding wire 12 in the slot 7 with the number 8 is electrically connected to the winding wire 12 in the slot 7 with the number 18.

The interconnection of the second winding mat 19 in the exemplary embodiment shown in FIG. 4 is made on the second end face “b” as follows:
The winding wire 20 in the slot 7 with the number 20 is electrically connected to the winding wire 20 in the slot 7 with the number 28.
The winding wire 20 in the slot 7 with the number 21 is electrically connected to the winding wire 20 in the slot 7 with the number 29.
The winding wire 20 in the slot 7 with the number 23 is electrically connected to the winding wire 20 in the slot 7 with the number 31.
The winding wire 20 in the slot 7 with the number 24 is electrically connected to the winding wire 20 in the slot 7 with the number 32.
The winding wire 20 in the slot 7 with the number 26 is electrically connected to the winding wire 20 in the slot 7 with the number 34.
The winding wire 20 in the slot 7 with the number 27 is electrically connected to the winding wire 20 in the slot 7 with the number 35.

The interconnection of the second winding mat 19 in the exemplary embodiment shown in FIG. 4 is made on the first end face “a” as follows:
The winding wire 20 in the slot 7 with the number 19 is electrically connected to the winding wire 20 in the slot 7 with the number 29.
The winding wire 20 in the slot 7 with the number 20 is electrically connected to the winding wire 20 in the slot 7 with the number 30.
The winding wire 20 in the slot 7 with the number 22 is electrically connected to the winding wire 20 in the slot 7 with the number 32.
The winding wire 20 in the slot 7 with the number 23 is electrically connected to the winding wire 20 in the slot 7 with the number 33.
The winding wire 20 in the slot 7 with the number 25 is electrically connected to the winding wire 2 in the slot 7 with the number 35.
The winding wire 20 in the slot 7 with the number 26 is electrically connected to the winding wire 20 in the slot 7 with the number 36.

It can be readily seen from FIG. 4 that the interconnection 24 of the first group of winding wires 12 of the first winding mat 10 and the second group of winding wires 20 of the second winding mat 19 is identical.

Furthermore, it can be seen from FIG. 4 that after the winding wires 12 of the first winding mat 10 have repeatedly passed through the stator 1, they each terminate on the other side (a,b) of the winding head near the air gap. For example, the winding wire 12 protruding from the stator 1 ends in the slot 7 with the number 1 (A1) on the first end face “a” in the slot 7 with the number 3 (A1) on the second end face “b” of the stator 1.

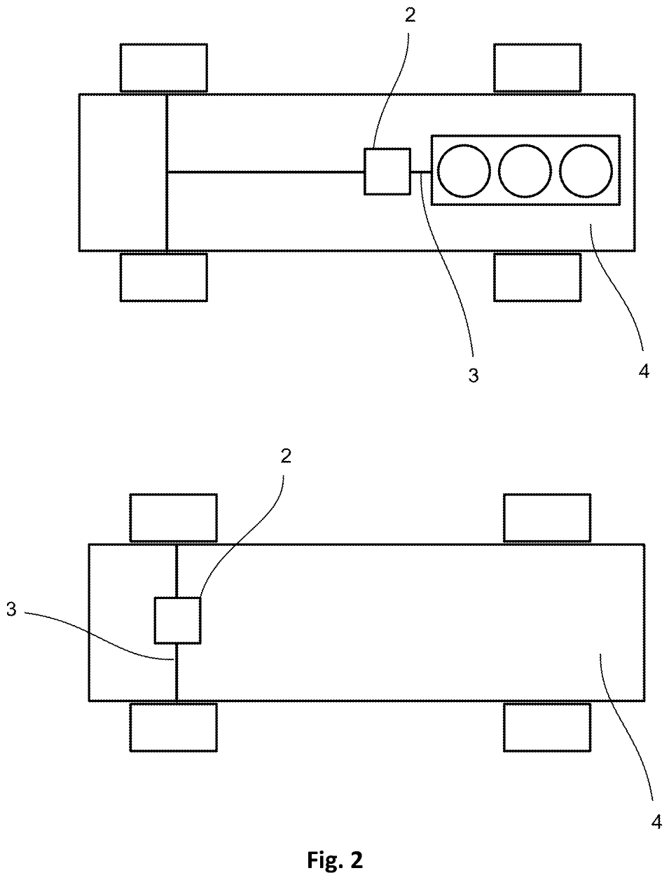

In particular, the stator 1 is intended for use in a hybrid or fully electric drive train 3 of a motor vehicle 4, as exemplarily shown in FIG. 2.

The disclosure is not limited to the embodiments shown in the figures. The above description is therefore not to be regarded as limiting, but rather as illustrative. The following claims are to be understood as meaning that a named feature is present in at least one embodiment according to the disclosure. This does not exclude the presence of further features. If the patent claims and the above description define ‘first’ and ‘second’ features, this designation serves to distinguish between two features of the same type without defining an order of precedence.

### LIST OF REFERENCE SYMBOLS

1 Stator
2 Electric machine
3 Drive train
4 Motor vehicle
5 Opening
6 Cylinder jacket surface
7 Stator slots
8 Stator windings
9 Winding wires
10 Winding mat
12 Winding wires
13 Winding ends
14 Slot base
15 Air gap
16 Rotor
17 Winding end
18 Winding end
19 Winding mat
20 Winding wires
21 Winding ends
22 Winding end
23 Winding end
24 Interconnection
25 Stator teeth
26 Housing
27 Polarity

1. A stator for an electric machine, the stator comprising:
a stator body having a cylindrical opening which extends axially through the stator and on which a plurality of stator slots are present, said stator slots being arranged in a peripherally distributed manner and extending radially outward from an inner cylinder jacket surface of the cylindrical opening and being formed over an entire axial length of the stator;
the stator slots each have a slot base on a radially outer end thereof and an air gap to a rotor, which is adapted to be received in the cylindrical opening, on a radially inner end thereof;
stator windings having winding wires arranged in the stator slots, the stator windings comprise a wave winding having a first winding mat and a second winding mat;
the first winding mat has a group of first ones of the winding wires, with winding ends of the group of first winding wires each arranged above a same one of the stator slots in each case, and the winding ends of the first group of winding wires each have a first winding end and a second winding end, the first winding end of the first group of winding wires abuts facing the slot base and the second winding end of the first group of winding wires abuts facing the air gap of said stator slot, and
the second winding mat has a group of second ones of the winding wires, the winding ends of the group of second winding wires are each arranged above a same one of the stator slots in each case, and the winding ends of the second group of winding wires each have a first winding end and a second winding end, the first winding end of the second group of winding wires abuts facing the slot base and the second winding end of the second group of winding wires abuts facing the air gap of said stator slot.

2. The stator according to claim 1, wherein the winding ends of the first group of winding wires and the winding ends of the second group of winding wires are arranged opposite each other in a circumferential direction in the stator slots of the stator.

3. The stator according to claim 1, wherein the first winding mat and the second winding mat are formed substantially identically.

4. The stator according to claim 1, wherein the winding ends of the first group of winding wires are arranged in circumferentially adjacent stator slots.

5. The stator according to claim 1, wherein the stator windings are designed for use in a 3-phase rotating field machine.

6. The stator according to claim 1, wherein an interconnection of the first group of winding wires of the first winding mat and the second group of winding wires of the second winding mat is identical.

7. The stator according to claim 1, wherein the stator windings have a number n of more than two winding mats and the winding mats are arranged circumferentially offset from one another by n/360° in the stator slots of the stator.

8. The stator according to claim 1, wherein the winding ends of the second group of winding wires are arranged in circumferentially adjacent stator slots.

9. A stator for an electric machine, the stator comprising:
a stator body having a cylindrical opening which extends axially through the stator from which a plurality of stator slots extend, said stator slots being arranged in a peripherally distributed manner and extending radially outward from the cylindrical opening and being formed over an entire axial length of the stator;
the stator slots each have a slot base on a radially outer end thereof and an air gap facing the cylindrical opening at a radially inner end thereof;
stator windings arranged in the stator slots, the stator windings comprise a wave winding having a first winding mat and a second winding mat;
the first winding mat has a group of first winding wires, with winding ends of the group of first winding wires each arranged above a same one of the stator slots in each case, and the winding ends of the first group of winding wires each have a first winding end and a second winding end, the first winding end of the first group of winding wires abuts facing the slot base and the second winding end of the first group of winding wires abuts facing the air gap of said stator slot; and
the second winding mat has a group of second winding wires, the winding ends of the group of second winding wires are each arranged above a same one of the stator slots in each case, and the winding ends of the second group of winding wires each have a first winding end and a second winding end, the first winding end of the second group of winding wires abuts facing the slot base and the second winding end of the second group of winding wires abuts facing the air gap of said stator slot.

10. The stator according to claim 9, wherein the winding ends of the first group of winding wires and the winding ends of the second group of winding wires are arranged opposite each other in a circumferential direction in the stator slots of the stator.

11. The stator according to claim 9, wherein the first winding mat and the second winding mat are formed substantially identically.

12. The stator according to claim 9, wherein the winding ends of the first group of winding wires are arranged in circumferentially adjacent stator slots.

13. The stator according to claim 9, wherein the stator windings are designed for use in a 3-phase rotating field machine.

14. The stator according to claim 9, wherein an interconnection of the first group of winding wires of the first winding mat and the second group of winding wires of the second winding mat is identical.

15. The stator according to claim 9, wherein the stator windings have a number n of more than two winding mats and the winding mats are arranged circumferentially offset from one another by n/360° in the stator slots of the stator.

16. The stator (1) according to claim 9, wherein the winding ends of the second group of winding wires are arranged in circumferentially adjacent stator slots.
